(19) United States
(12) Patent Application Publication
(10) Pub. No.: US 2020/0294167 A1
(43) Pub. Date: Sep. 17, 2020

(54) SYSTEMS AND METHODS FOR AIDING HIGHER EDUCATION ADMINISTRATION USING MACHINE LEARNING MODELS

(71) Applicant: Ellucian Company L.P., Reston, VA (US)

(72) Inventors: Andrew KING, Reston, VA (US); James Brian KNOTTS, Reston, VA (US); Joseph WATTERS, Reston, VA (US); Robert LEVY, Reston, VA (US)

(21) Appl. No.: 16/816,769

(22) Filed: Mar. 12, 2020

Related U.S. Application Data
(60) Provisional application No. 62/817,439, filed on Mar. 12, 2019.

(51) Int. Cl. G06Q 50/20; G06N 3/04; G06N 3/08; G06N 5/00; G06N 5/04; G06N 20/20

(52) U.S. Cl. CPC G06Q 50/205; G06N 3/0454; G06N 3/088; G06N 3/0445; G06N 5/04; G06N 20/20; G06N 5/003

(57) ABSTRACT

Systems and methods applicable, for instance, to using machine learning models to aid higher education administration. Various machine learning model-based tools can be provided. Further provided can be various infrastructure software modules.

### CROSS-REFERENCE TO RELATED APPLICATIONS

This application claims priority to U.S. Provisional Patent Application Ser. No. 62/817,439, filed on Mar. 12, 2019, the contents of which are incorporated herein by reference in their entirety and for all purposes.

### FIELD OF THE INVENTION

The present technology relates to the field of aiding higher education administration. More particularly, the present technology relates to techniques for aiding higher education administration using machine learning models.

### BACKGROUND OF THE INVENTION

Administration within the higher education space can involve a multitude of challenging goals. For example, considering admissions, a higher education institution can have a goal of increasing or maintaining student body size. Achievement of this goal can be difficult because, for instance, not all applicants who are offered admission to the institution will choose to attend.

As further examples, once a given student is attending a higher education institution, there can be a goal of promoting appropriate course selection by the student, and/or a goal of ensuring establishment of an effective schedule for the student. Here, difficulties can include ensuring that the student's graduation requirements are met in a timely fashion. As another example, once a given student is attending a higher education institution, the student may express interest in changing their major. A such, there can be an administrative goal of formulating useful and effective suggestions of alternative possible majors for the student.

As additional examples, a higher education institution can have a goal of promoting overall student retention at the institutional level, and/or a goal of encouraging the continued enrollment of individual students. here, difficulties can include properly identifying factors that can contribute to student success and failure at the institutional level, and properly recognizing when a given student is at risk of withdrawing.

Due to factors such as the rise of modern computer systems, a higher education institution can have access to a large amount of data, for instance data regarding its students and applicants, and publicly-accessible data. However, the institution can be unsure as to how to harness this data to meet goals and inform decisions.

As such, there is call for technologies which are applicable to helping higher education institutions harness data to meet goals and inform decisions.

### BRIEF DESCRIPTION OF THE DRAWINGS

FIG. 1 shows a course recommendations/automated scheduling tool, according to various embodiments.

FIG. 2 shows multiple tree paths, according to various embodiments.

FIG. 3 shows a gated recurrent unit (GRU)-based recurrent neural network (RNN) of an admissions funnel forecasting tool, according to various embodiments.

FIG. 4 shows a user interface (UI) of the admissions funnel forecasting tool, according to various embodiments.

FIG. 5 shows infrastructure software modules, according to various embodiments.

FIG. 6 shows a research cycle, according to various embodiments.

FIG. 7 shows research/production module and endpoint service functionality, according to various embodiments.

FIG. 8 shows an example computer, according to various embodiments.

### DETAILED DESCRIPTION

According to various embodiments, there are provided systems and methods for aiding higher education administration using machine learning models. Such systems and methods include ones by which there can be provision of machine learning model (MLM)-based tools which inform higher education administration decisions. As examples, these tools can include a course recommendations/automated scheduling tool, an early warning student retention tool, and an institutional retention factor analysis tool. As further examples, these tools can include an admissions funnel forecasting tool, an institutional retention forecasting tool, and a student major recommendation system tool. These tools can be accessed by and/or integrated into various software applications for higher education support and administration. In this way, the tools can aid higher education administration by, as just some examples, making recommendations to help meet administrative goals, returning actionable insights, flagging suboptimal operations, and identifying potential points of student success and failure.

In various embodiments, these tools—and MLMs upon which they are based—can be supported by various infrastructure software modules. Such infrastructure software modules can include a data access/domain model module, a data lake module, a research/production module, and a model consumption module.

With regard to each of the various MLMs discussed herein, it is noted that according to various embodiments, a single MLM can be trained for use by multiple higher education institutions, while in other embodiments a separate MLM can be trained for each higher education institution. Also, the functionality described herein can, in various embodiments, be implemented using various cloud computing services (e.g., using Amazon Web Services (AWS), Microsoft Azure or another infrastructure as a service provider). Various aspects will now be discussed in greater detail.

### Tools: Course Recommendations/Automated Scheduling Tool

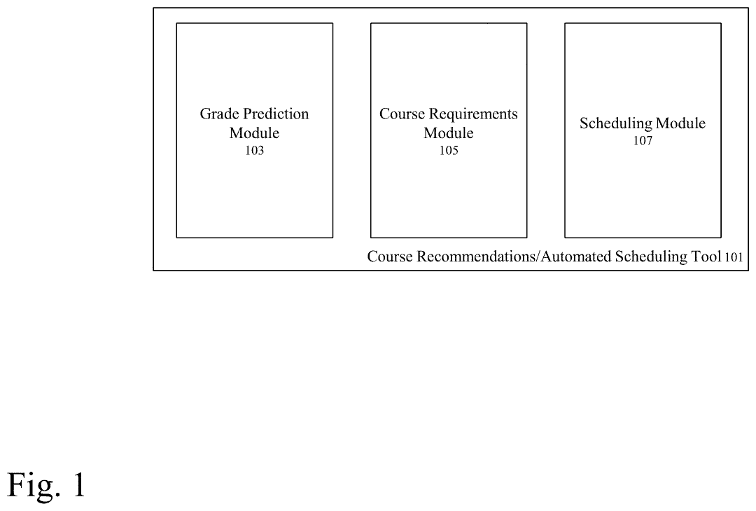

According to various embodiments, a course recommendations/automated scheduling tool can be provided. The course recommendations/automated scheduling tool is a tool that can assess graduation requirements that a given student has not yet fulfilled, and can create multiple possible course schedules for the student. The schedules which the tool creates can include courses determined by the tool to be ones in which the student is likely to enjoy academic success. Moreover, the schedules which the tool creates can be arranged in optimal (or near optimal) ways. With reference to FIG. 1, The course recommendations/automated scheduling tool 101 can, according to various embodiments, utilize a grade prediction module 103, a course requirements module 105, and a scheduling module 107.

Turning to the grade prediction module 103, it is noted that the grade prediction module 103 can utilize an MLM. According to various embodiments, the MLM utilized by the grade prediction module 103 can be an autoencoder neural network (e.g., a denoising autoencoder). The autoencoder can, for example, be implemented using a machine learning library such as PyTorch. The MLM, once trained, can take a student's course history and grades as input, and output a vector (e.g., a dense vector) with grade predictions for courses (e.g., all offered courses) that the student has not taken. In some embodiments, the vector can have an element for each course offered by the relevant educational institution. Subsequently, the course recommendations/automated scheduling tool 101 can utilize the vector outputted by the MLM to ascertain courses at which the student is expected to excel. In some embodiments, the course recommendations/automated scheduling tool 101 can rank the courses according to expected academic success.

In some embodiments, a training dataset for the autoencoder can be compiled using historical student data. This student data can reference students by ID, and can specify the courses which the students have taken along with grades earned (e.g., on a 4.0 scale). In particular, training data outputs can be made up of vectors which, for each of various students, convey all courses taken/grades earned by the student, while training data inputs can be made up of corresponding vectors for which various courses taken/grades earned have been removed. As such, the training data inputs can be viewed as a masking out of student history portions. In one example, the training dataset can reference approximately 256,000 students and approximately 7,500 courses. The student data can, in various embodiments, be split into the training dataset and a test dataset, facilitating a determination of how well the autoencoder can reconstruct removed/masked out data.

As an example, the autoencoder can utilize the following layer structure:
Encoder(N-2048-1024-256-64)
Decoder(64-256-1024-2048-N).

As such, the autoencoder can have a total of 10 layers, with the encoder and decoder portions each having five linear layers with the specified number of neurons. Each layer except the final layer in the encoder can advantageously have a pRELU activation function. In the above, N is the number of courses referenced by the vectors of the training data inputs and training data outputs (e.g., the number of courses offered by the relevant educational institution).

Once trained, the autoencoder can be presented with a vector which corresponds to a student for whom course recommendations/automated scheduling is desired. The vector can have an element for each class offered by the relevant educational institution. For those of the offered classes which have been taken by the student, the grade achieved by the student (e.g., on a 4.0 scale) for the class can be placed in the corresponding element of the vector. As the student will likely not have taken all classes offered, certain elements of the vector will not contain grades. From one vantage point, the vector can be treated by the autoencoder as a “corrupted” vector insofar as certain elements of the vector do not contain grades. As such, the autoencoder can act to “reconstruct” the vector by predicting grade values for those elements of the vector which are devoid of grades. As those elements of the vector devoid of grades correspond to classes not taken by the student, in this way the autoencoder can predict—for all classes which the student has not taken—a grade which the student might be expected to receive in the class.

Utilizing a custom autoencoder, as discussed, can provide advantages over alternative approaches such as employing singular value decomposition or non-negative matrix factorization. For example, online learning can be difficult with such alternative approaches, as such approaches usually require a new matrix to be calculated any time results are desired for a new student. In contrast, the autoencoder utilized by the course recommendations/automated scheduling tool 101 allows the neural network thereof to be trained, and subsequently run against any student regardless of their previous inclusion in the training dataset or not.

Turning to the course requirements module 105, it is noted that the course requirements module 105 can, in a first operation, ascertain degree requirements for a particular student's declared major (or general institutional requirements in the case of an undeclared student). In a second operation, the course requirements module 105 can determine those of the classes selectable for scheduling which help satisfy those requirements. As an illustration, where degree and/or institutional requirements dictate fulfillment of a physical science requirement, the course requirements module 105 can determine that there are six courses fulfilling that requirement offered in the term for which scheduling is to be performed. In various embodiments, the course requirements module 105 can, in performing the first and second operations, interface with one or more software modules and/or servers. For example, the course requirements module 105 can interface with Ellucian Degree Works and/or Ellucian CRM Advise.

Via the second operation, the course requirements module 105 can determine those of classes selectable for scheduling which help satisfy degree/institutional requirements. Then, via a third operation, the course requirements module 105 can utilize the grade prediction module 103 to learn of predicted grades for each of such selectable classes which help satisfy requirements. Further via the third operation, the course requirements module 105 can use these predicted grades to select, for each requirement for which at least one class is available for selection, a given quantity of such classes (e.g., three or one) for which the grade prediction module 103 predicts highest grades for the at-hand student. As an illustration, returning to the example of there being six selectable classes meeting a physical science requirement, the grade prediction module 103 can provide for each of these classes a predicted grade. Using this information, where the course requirements module 105 is to select three classes, the course requirements module 105 can select those three of the six classes for which highest grades are predicted. As such, the course requirements module 105 can generate a list of courses wherein each listed course: a) helps the at-hand student fulfill a degree/institutional requirement; and b) is a course in which the at-hand student is likely to succeed. Subsequently, as will be discussed, the scheduling module 107 can use this list as a basis for formulating possible schedules for the at-hand student.

Turning to the scheduling module 107 the list of classes generated by the course requirements module 105 can be used by the scheduling module 107 as a basis for formulating possible schedules for the at-hand student. As noted, the course requirements module 105 can generate a list of courses. From this list, the scheduling component can initially eliminate any courses that the at-hand student cannot take due to scheduling conflicts. Such scheduling conflicts can include ones specified by the student (e.g., the student might specify a certain time/day as unavailable for class scheduling due to an apart-from-school commitment such as a student job). Such scheduling conflicts can also include ones identified by the module (e.g., the module can determine two or more classes to be mutually exclusive due to them taking place at identical or overlapping times). The module can also initially eliminate from the list classes which conflict with stated scheduling preferences of the student.

Subsequently, the scheduling module 107 can use various search and/or optimization strategies to generate potential schedules from the remaining classes. As one example, epsilon support vector machine regression can be used. As another example, the scheduling module 107 can utilize a regression tree, and consider various features such as course times and days of the week, credit hours, and course headers (CSC, BIO, etc.). In various embodiments, the regression tree can be used to rank potential schedules in terms of grade point average (GPA) expected value. Also, in various embodiments the scheduling module 107 can estimate the GPA of each given schedule: a) by using a pretrained classifier MLM; orb) by calculation using the grade estimates generated by the grade prediction module 103. Finally, the scheduling component can output for the at-hand student a given quantity of top (according to estimated GPA) schedules. In various embodiments, in generating and outputting such schedules for the student, the scheduling module 107 can generate and output schedules for varying course loads (e.g., number of credits).

### Tools: Early Warning Student Retention Tool

According to various embodiments, an early warning student retention tool can be provided. The early warning student retention tool can harness AI/machine learning in order to predict which students appear to be likely to withdraw. Such predictions can be utilized in various ways. For example, administrators, advisors, and others can preemptively intervene by offering support to a student for whom the tool predicts withdrawal. As such, the tool can give a higher education institution an opportunity to promote the success of struggling students on an individual level.

The early warning student retention tool can utilize an MLM. According to various embodiments, the MLM utilized by the early warning student retention tool can be classifier, for instance an XGBoost classifier or other gradient-boosted decision tree classifier.

In various embodiments, a training dataset for the MLM can be compiled using historical institutional data (e.g., courses taken and grades earned) regarding various students, and in some embodiments also historical data regarding external factors (e.g., the health of the economy). Further, the training dataset can include historical data regarding whether or not the students were at risk (e.g., withdrew within the year corresponding to the institutional and/or external historical data).

In particular, training data inputs can be made of up vectors which, for each of various students, convey the institutional data relating to the student (and in some embodiments also external data). The training data outputs can be made up of single element vectors which, for each of the various students, indicate whether or not the student was at risk (e.g., a given single element vector can hold a 1 where the given student was at risk, and a 0 where the given student was not at risk). In various embodiments, the noted data can be split into a training dataset and a testing dataset, thereby facilitating a determination of how well the trained MLM is able to predict student risk.

The MLM, once trained, can take institutional data regarding a student as input, and in various embodiments also external factors. Subsequently, the MLM can output a prediction of whether or not the student is at risk. For example, the MLM can output a value within the range 0 . . . 1, where higher values indicate that the student is more likely to be at risk (e.g., at risk of withdrawing from the relevant educational institution within the next year).

With further regard to the institutional data, it is noted that the institutional data can, as just some examples, include one or more of: a) amount paid in tuition (e.g., tuition minus scholarships); b) total per-semester tuition amount; c) student admission statistics; d) major (if declared); e) number of semesters attended; f) number of courses failed; g) average course grade; h) average number of courses taken per semester; and i) average number of students enrolled in courses taken. With further regard to the external data, it is noted that the external data can, as just some examples, include one or more of: a) resident status; b) country unemployment rate; c) local unemployment rate; and d) stock index rate change from year previous.

In some embodiments, the MLM can correspond to the Distributed Machine Learning Community (DMLC) implementation of XGBoost. Also, in some embodiments training of the MLM can utilize a distributed/cluster computing framework (e.g., Apache Spark).

As referenced the MLM, once trained, can take the noted institutional data (and in some embodiments external data) as inputs, and output predictions which can be used to identify at risk students. In some embodiments, software applications used in advising and/or managing students (e.g., Ellucian CRM Advise) can (e.g., via a corresponding endpoint) query the tool with respect to each of multiple students. In return, the tool can return MLM predictions conveying which of the students are at risk. In this way, a list of at-risk students can be compiled. Such a list can be used by the relevant institution for interventional purposes. In various embodiments, the MLM can also return confidence information for its predictions. Using this confidence information, the can be prioritized. Alternately or additionally, list prioritization can be performed based on cutoffs applied to MLM outputs. As just one example, students for whom the MLM yields an output of greater than 0.5 can be considered to be at risk, and such students can be prioritized according to the particular values outputted by the MLM (e.g., a student for whom the MLM outputted a 0.8 can be prioritized over a student for whom the MLM outputted an 0.6).

### Tools: Institutional Retention Factor Analysis Tool

According to various embodiments, an institutional retention factor analysis tool can be provided. The institutional retention factor analysis tool can help higher education institutions increase student retention at the institutional level—as opposed to, say, at the level of individual students—by ascertaining relevant factors of student success and/or failure (e.g., where failure is defined as withdrawing from an institution). In addition, the tool can analyze MLM tree paths. In this way, the tool can reveal factor combinations that are most likely to lead to student success or student failure, based on the analysis of outcomes of previous students.

In various embodiments, the institutional retention factor analysis tool can utilize the early warning student retention tool. In particular the institutional retention factor analysis tool can determine the weights employed by the MLM (e.g., an XGBoost classifier or other gradient-boosted decision tree classifier) of the early warning student retention tool, and use the determined weights in ascertaining relevant factors of student success and/or failure. As just one example, such factors can be ones which relate to whether or not students will be retained by a given higher education institution.

In ascertaining such relevant factors, the institutional retention factor analysis tool can consider each feature (i.e., input) provided to the MLM of the early warning student retention tool. Where the MLM is an XGBoost classifier or other gradient-boosted decision tree classifier, with respect to each of the features the institutional retention factor analysis tool can average the information gain of the tree classifier splits which use that feature. In this way, the tool can gain an understanding of how each of the features is weighted within the MLM. Where the MLM is other than an XGBoost classifier or other gradient-boosted decision tree classifier, an appropriate weight-extraction approach corresponding to the type of the MLM can be used.

The strength at which a given feature is weighted within the MLM can be taken by the institutional retention factor analysis tool to be indicative of the relevance of that feature. In this way, relevant features can be considered by the tool to be relevant factors of student success and/or failure (e.g., where “average number of courses taken per semester” is found to be a strongly weighted feature, average number of courses taken per semester can be taken to be a relevant factor).

In various embodiments, the institutional retention factor analysis tool can subsequently rank the determined factors. Moreover, according to various embodiments the tool can display the ranked factors and their importances via a UI. As just one example, results of the institutional retention factor analysis tool can be displayed in connection with one or more educational analytics software applications or services (e.g., Ellucian Analytics).

As noted, the institutional retention factor analysis tool can, in various embodiments, utilize as its MLM an XGBoost classifier or other gradient-boosted decision tree classifier of the early warning student retention tool. In these embodiments, the institutional retention factor analysis tool can analyze the internal structure of such an employed decision tree to generate insights into various factors and sets of factors which tend to result in given outcomes/outputs being generated by the MLM.

In particular, in generating a given outcome/output based on received inputs, such a tree-based MLM traverses one of multiple possible tree paths. Each such path corresponds to a possible set of factors that hold for students with certain outcomes. By analyzing one or more of these tree paths in terms of corresponding outcomes/outputs, the tool can generate (e.g., for presentation to a higher education institution via a UI) one or more of detailed information about: a) a particular set of factors and corresponding values which led to a given outcome/output being generated by the MLM; and b) overall guidance concerning correlations between various sets of factors and corresponding values, and resultant outcomes/outputs. The tree structure of an employed tree-based classifier can provide hundreds if not thousands of paths to assess and/or rank.

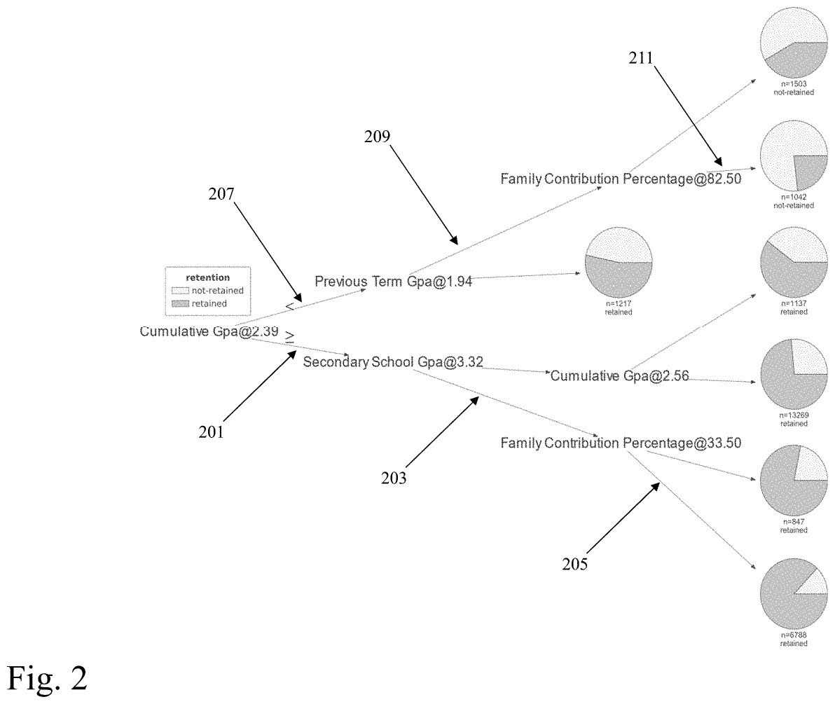

For example, turning to FIG. 2, shown is an example of multiple tree paths of the sort noted. Within FIG. 2, upper portions of splits are indicative of departing a node via a less than (i.e., “<”) relationship, while lower portions of splits are indicative of departing a node via a greater-than-or-equal-to (i.e., “≥”) relationship. For example, traveling from node “Cumulative Gpa@2.39” to the node “Previous Term Gpa@1.94” involves departing node “Cumulative Gpa@2.39” via the upper split portion, and therefore involves a cumulative GPA of less than 2.39. Likewise, as another example, traveling from node “Cumulative Gpa@2.39” to the node “Secondary School Gpa@3.32” involves departing node “Cumulative Gpa@2.39” via the lower split portion, and therefore involves a cumulative GPA of greater-than-or-equal-to 2.39.

Among the tree paths depicted by FIG. 2 are: a) a first tree path, corresponding to traveling from node “Cumulative Gpa@2.39” to node “Secondary School Gpa@3.32” to node “Family Contribution Percentage@33.50,” and then to outcome “n=6788 retained”; and b) a second tree path, corresponding to traveling from node “Cumulative Gpa@2.39” to node “Previous Term Gpa@1.94” to node “Family Contribution Percentage@82.50,” and then to outcome “n=1042 non-retained”. Note that the numbers used in the example are only illustrative, and specific numbers can vary by institution and dataset.

According to the example of FIG. 2, the tool can, by analyzing the depicted tree paths, firstly determine, by analyzing the first tree path, that students who: a) maintain a cumulative GPA of 2.39 or above (201); b) had a secondary school GPA of 3.32 or above (203); and c) whose family contribution percentage is 33.5 percent or more of the total cost of attendance (205), are very likely to have a successful outcome. In contrast, the tool can, by analyzing the second tree path, secondly determine that students who: a) maintain a cumulative GPA below 2.39 (207); b) had a previous term GPA below 1.94 (209); and c) whose family contribution percentage is 82.5 percent or more of the total cost of attendance (211), are very unlikely to have a successful outcome. Tree path analysis by the tool can include, for instance, grouping and ranks the factors of various tree paths.

Results of the tree path analysis of the sort discussed can, as just one example, be displayed in connection with one or more tools and/or products (e.g., in connection with Ellucian Analytics, or other educational analytics software applications or services. In this way, such results can, for instance, provide valuable insights to higher education institutions.

As such, the institutional retention factor analysis tool can allow higher education institutions to determine the top factors that contribute to student success and/or failure.

### Tools: Admissions Funnel Forecasting Tool

According to various embodiments, an admissions funnel forecasting tool can be provided. The admissions funnel forecasting tool can assist higher education institutions in accomplishing goals such as increasing the size of the student body or maintaining an optimal number of students.

The admissions funnel consists of three metrics: the number of students that apply to a higher education institution, the number (or percentage) that are admitted to the institution, and the number (or percentage) that ultimately attend the institution. The admissions funnel forecasting tool can act to predict admissions tunnel information for points of time in the future (e.g., the tool can predict the three admissions tunnel metrics for a year which has yet to occur).

The admissions funnel forecasting tool can utilize an MLM in making such predictions. As an example, the MLM utilized by the admissions funnel forecasting tool can be an RNN. In various embodiments, the RNN can use GRU neurons. In other embodiments, a different type of neuron can be used (e.g., Long Short-Term Memory (LTSM) neurons can be used). According to various embodiments, the RNN can include three hidden layers, and three hidden features can be passed between the layers of the network.

A training dataset for the MLM can be complied using historical admissions tunnel data. Such historical admissions tunnel data can be in the form of three-value vectors (each containing the three noted admissions tunnel metrics), wherein each vector corresponds to a point in time in the past (e.g., to a year in the past). In particular, a given training data input can be made up of a sequence of j such vectors, where each vector of the sequence corresponds to a point of time (e.g., year) within the range t₁ . . . tⱼ. Then, a corresponding training data output can be made up of a sequence of j such vectors, where each vector of the sequence corresponds to a point of time (e.g., year) within the range t₂ . . . tⱼ₊₁. The value of j can differ among training data instances (e.g., one training data instance might have three vectors in its input and output sequences, while a different training data instance might have five vectors in its input and output sequences).

As an illustration, a given training data input sequence can be made up of a vector for the year 2010, followed by a vector for the year 2011, followed by a vector for the year 2012. Further according to the illustration, the corresponding training data output sequence can be made up of the vector for the year 2011, followed by the vector for the year 2012, followed by a vector for the year 2013. In some embodiments, overlap can be employed in compiling the particular training data inputs and outputs. In these embodiments, illustratively, for example, one training data input sequence can be made up of vectors for the years 2010-2013, while a subsequent training data input sequence can be made up of vectors for the years 2011-2014. In other embodiments, overlap is not employed in compiling the training data inputs and outputs. In these embodiments illustratively, for example, one training data input can be made up of vectors for the years 2010-2013, while a subsequent training data input can be made up of vectors for the years 2014-2017.

Once trained, the RNN can receive an input sequence X of j such vectors, and generate a predictive output sequence Y of j such vectors, where the sequence X contains j vectors each corresponding to a point of time within the range t₁ . . . tⱼ, and where the sequence Y contains j vectors each corresponding to a point of time within the range t₂ . . . tⱼ₊₁. The value of j can differ among input sequences passed to the RNN in pursuit of a prediction (e.g., one prediction request might include four vectors in its input sequence, while another prediction request might include six vectors in its input sequence).

In this way, for each vector which the trained RNN receives as input, the RNN can generate as output a corresponding predictive vector for a subsequent timepoint. As an illustration, when receiving, as input, vectors for the years 2019-2021, the RNN can output predictive vectors for the years 2020-2022. Accordingly: a) the 2020 output vector represents the generated prediction corresponding to the 2019 input vector; b) the 2021 output vector represents the generated prediction corresponding to the 2020 input vector; and c) the 2022 output vector represents the generated prediction corresponding to the 2021 input vector. Accordingly, the trained RNN provides the admissions funnel forecasting tool with a robust ability to make admissions funnel predictions for higher education institutions.

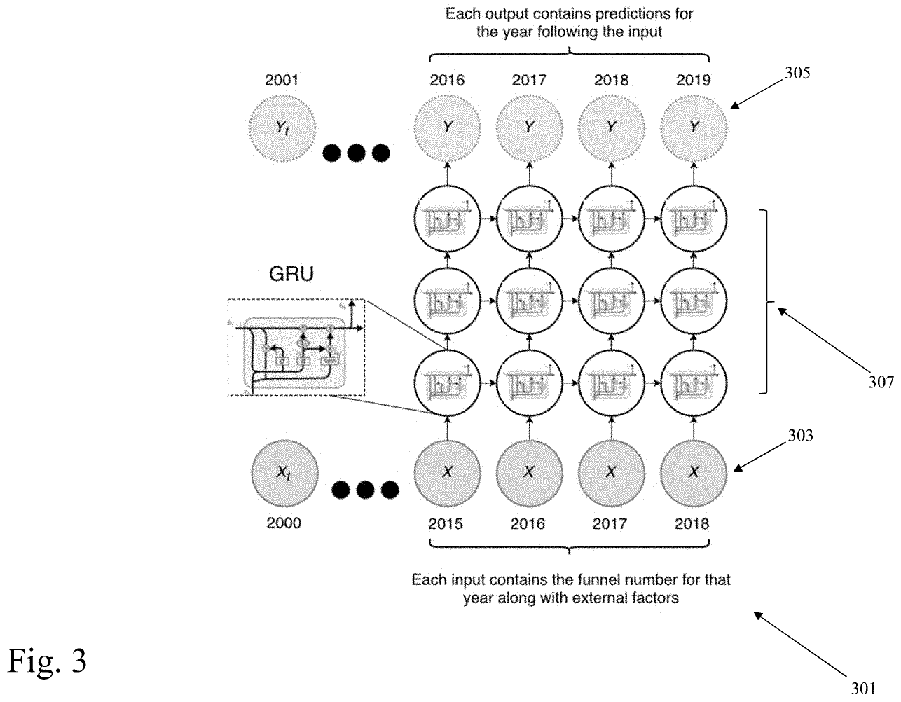

As referenced, the trained RNN can be used to generate predicted funnel vectors for times in the future. For example, supposing a current year of 2021, the RNN can be passed an input sequence of funnel vectors for the years 2018-2021. In reply, the RNN can generate an output sequence made up of predictive funnel vectors corresponding to the years 2019-2022, thereby generating predictive funnel data for yet-to-occur year 2022. Turning to FIG. 3, shown is an example of a GRU-based RNN 301 for the admissions funnel forecasting tool. As depicted by the figure, the RNN of FIG. 3 can be passed an input sequence of funnel vectors for the years 2000-2018 (303). In reply, the RNN of FIG. 3 can generate an output sequence made up of predictive funnel vectors corresponding to the years 2001-2019 (305). As such, assuming for the example of FIG. 3 a current year of 2018, the RNN of FIG. 3 generates predictive funnel data for yet-to-occur year 2019. Also depicted by FIG. 3 are the three hidden layers 307 of the RNN of FIG. 3.

As another example, also supposing a current year of 2021, the RNN can, in various embodiments, be passed a one-element input sequence made up of a tunnel vector for the year 2021. In reply, the RNN can generate a one-element output sequence, made up of a predictive funnel vector for the year 2022. As just discussed, the trained RNN can generate a predicted funnel vector from a single-vector input sequence. However, according to various embodiments, other approaches can be used for generating a predicted funnel vector from a smaller amount of input data. For instance, a triple exponential smoothing statistical model (e.g., Holt-Winters) approach can be used. As just one example, such an alternative approach can be used where an admissions funnel prediction is desired for a given higher education institution, but the there is only a limited number of years of funnel data (e.g., 1-2 years) available for formulating input sequences for a trained RNN.

Discussed has been a many-to-many RNN configuration wherein the RNN, once trained, receives an input sequence of j vectors, and generates a predictive output sequence of j vectors. However, according to various embodiments a many-to-one RNN configuration can be used. In these embodiments, the RNN can be trained to receive an input sequence of j vectors, and output a single-vector sequence. In particular, the RNN can be trained to receive an input sequence of j vectors each corresponding to a point of time within the range t₁ . . . t₁, and generate a single-vector sequence made up of a vector corresponding to the point of time tⱼ₊₁. As an illustration (assuming a current year of 2025), in these embodiments passed to the RNN can be an input sequence of funnel vectors for the years 2019-2025. Further according to the illustration, the RNN can return a single-vector sequence made up of a predicted funnel vector for the year 2026.

Although the MLM taking as input and generating as output three-element admissions tunnel data vectors has been discussed, according to various embodiments differently-sized vectors can be used. For example, in various embodiments the RNN can learn to generate output sequences of three-value tunnel vectors not from input sequences of three-value tunnel vectors as discussed, but rather from input sequences of expanded vectors, which are larger than three elements in size. In particular, such expanded vectors can include not only the noted three admissions tunnel data items, but also elements conveying data for external factors (e.g., country unemployment rate, local unemployment rate, stock index data, and/or birth numbers). In such embodiments, this external factor data can be included in the training set data.

According to various embodiments, the training dataset for the RNN can be compiled using various educational information datasets (e.g., the Integrated Postsecondary Education Data System (IPEDS) dataset from the National Center for Education Statistics (NCES) can be used). As just one illustration, training can utilize data from 2,860 higher education institutions with an average of 11.62 years of data from each institution, yielding 33,231 total years of institutional data for training of the MLM. Also, according to various embodiments, a single RNN can be trained for use by multiple higher education institutions. In other embodiments, a separate RNN can be trained for each higher education institution. In these embodiments, the training dataset for the RNN can include funnel data for that institution. Further in these embodiments, where there is only a limited number of years of funnel data (e.g., 1-2 years) available for training the RNN, the tool can use other approaches for predicting funnel data as a supplement to or in lieu of an RNN. For example, a triple exponential smoothing statistical model (e.g., Holt-Winters) can be used.

The admissions funnel forecasting tool can use the trained RNN in a number of ways. For example, as referenced above, the tool can use the RNN to generate a three-value admissions funnel vector for a point (e.g., year) in the future. As another example, the tool can leverage the trained RNN in making specific recommendations to a higher education institution. For instance, suppose that the RNN predicts an ultimately-will-attend funnel value which would lead to over-enrollment at a particular institution (e.g., a number of enrolled students exceeding a desired enrollment amount provided by the institution). Under this circumstance, the tool can suggest that the institution reduce the quantity of students admitted. Further for instance, suppose that the RNN predicts an ultimately-will-attend funnel value which would lead to under-enrollment at a particular institution (e.g., a number of enrolled students falling below a desired enrollment amount provided by the institution). Under this circumstance, the tool can suggest that the institution increase the quantity of students admitted. As such, the tool enables universities to prevent problems, such as over- or under-enrollment.

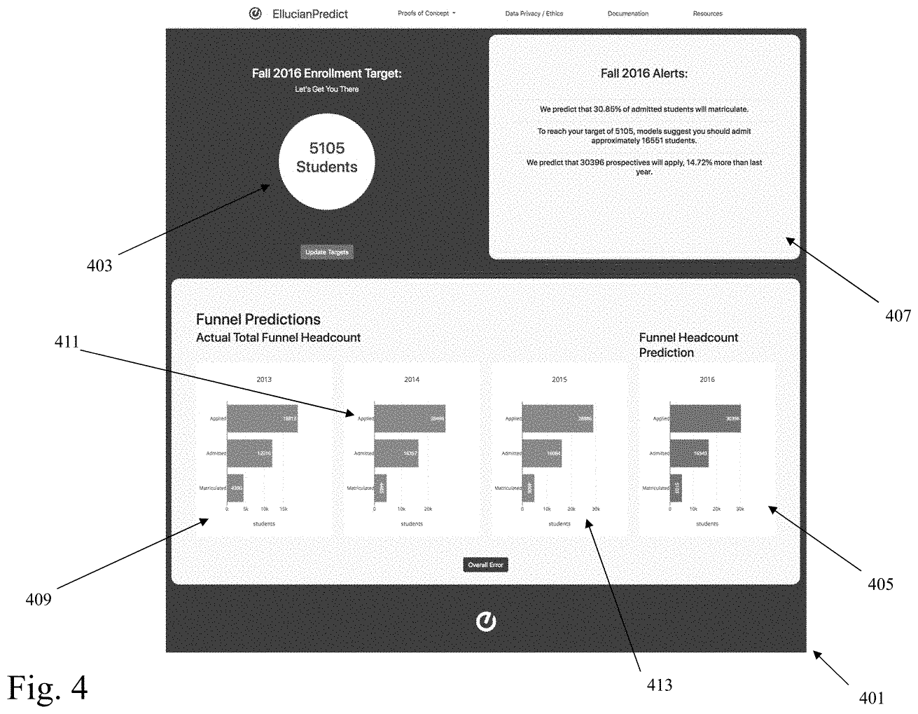

Shown in FIG. 4 is an example UI 401 of the admissions funnel forecasting tool. For the example of FIG. 4, assume a point in time at which the last class to have been admitted is one which entered for the fall of 2015, and at which the class to enter for the fall of 2016 is currently being selected. Using the UI 401, a higher education administrative user has indicated a desired fall 2016 enrollment target of 5105 students (403). In reply, the tool has used its RNN to generate a predicted funnel vector for yet-to-occur fall of 2016. In a first aspect, the tool has displayed, to the administrative user via UI bar chart view element 405, information regarding this predicted tunnel vector. In a second aspect, the tool has displayed, to the administrative user via UI label element 407, various information drawing from the predicted tunnel vector and the specified fall 2016 enrollment target. As such, among the information provided by the tool via UI label element 407 is the suggestion “To reach your target of 5105, we suggest you should admit approximately 16551 students.” Also shown in the example of FIG. 4 are UI bar chart view elements 409, 411, and 413, via which the tool displays information regarding actual tunnel vectors for the years 2013, 2014, and 2015. Such actual tunnel vectors can, for instance, reflect funnel vectors which were passed as input to the RNN in connection with the generation of the predicted funnel vector for fall of 2016.

Moreover, in various embodiments, the admissions funnel forecasting tool can utilize one or more further MLMs. For instance, in various embodiments an autoencoder can be trained, in a manner analogous to that discussed in connection with the course recommendations/automated scheduling tool 101, to receive as input an admissions funnel vector having fewer than three elements, and return an admissions funnel vector which includes the missing elements. Using this functionality, the admissions funnel forecasting tool can inform various higher education administration decisions. As one example, supplied by the institution (e.g., via a UI) with a quantity of students which have applied and also a desired quantity of matriculating students, the tool can use the autoencoder to generate the “missing” that-are-admitted funnel value. Such generated value can then be suggested to the institution as a quantity of students to admit.

As such, by making admissions funnel predictions, the tool can provide, for instance, automated guidance to institutions as to how many students they should admit to meet a various enrollment targets. In some embodiments, the tool can also surface other metrics. For example, the tool can present predicted funnel values in terms of year-over-year changes relative to past funnel values (e.g., the tool can present a predicted students-that-will apply funnel value as a year-over-year change relative to a past students-that-will apply funnel value).

### Tools: Institutional Retention Forecasting Tool

According to various embodiments, an institutional retention forecasting tool can be provided. The institutional retention forecasting tool can provide predictions regarding institutional retention. As an example, such an institutional retention prediction can convey a prediction of the percentage of students that will still be enrolled at a given institution one year after enrolling there as incoming freshmen. As such, according to this example the tool can generate institutional retention predictions which are in keeping with the NCES definition of retention.

The institutional retention forecasting tool can utilize an MLM in generating such predictions. As an example, the MLM utilized by the tool can be an RNN. In some embodiments, the RNN can use GRU neurons. In other embodiments, a different type of neuron can be used (e.g., LTSM neurons can be used). According to various embodiments, the RNN can include two hidden layers, and a single hidden feature can be passed between the layers of the network.

A training dataset for the MLM can be compiled using historical institutional data, and in some embodiments also historical external data. Such historical institutional data (and in some embodiments also external data) can be in the form off-value vectors, where f is the quantity of data factors utilized (e.g., where 17 institutional/external factors are used by the tool, f=17). Further, the training dataset can include historical data values regarding student retention. In particular, a given training data input can be a single-vector sequence, wherein the vector is an f-value vector of the sort noted, and wherein the vector corresponds to a point in time (e.g., year) t. Additionally in particular, a corresponding training data output can be made up of a sequence of r student retention values, where each value of the sequence corresponds to a point of time (e.g., year) within the range t+1 . . . t+r. According to various embodiments, r=3. In other embodiments, a different value can be used for r. Moreover, in various embodiments the value of r can differ among training data instances.

As an illustration where r=3, a given training data input sequence can be a single-vector sequence, made up of a single vector (of institutional, and in some embodiments also external data) corresponding to the year 2010. Further according to the illustration, the corresponding training data output sequence can be a three-value sequence, made up of a student retention value for the year 2011, followed by a student retention value for the year 2012, followed by a student retention value for the year 2013.

Once trained, the RNN can receive a single-vector sequence, made up of an f-value vector of the sort noted, corresponding to a point in time t. In return, the RNN can output a sequence of r generated student retention values, where each value of the sequence corresponds to a point of time within the range t+1 . . . t+r. The value of r can differ among input sequences passed to the RNN in pursuit of predictions. Accordingly, the institutional retention forecasting tool can, once trained, act to predict student retention values for r points of time in the future (e.g., the tool can predict student retention values for r years which have yet to occur).

As an illustration, suppose a current year of 2021, and r=3. According to this illustration the RNN can receive, as input, a single-vector sequence (of institutional, and in some embodiments also external data) corresponding to the year 2021. In reply, the RNN can generate a three value sequence, made up of a student retention value for the year 2022, followed by a student retention value for the year 2023, followed by a student retention value for the year 2024. In this way, the RNN can generate predictive funnel data for r=3 yet-to-occur years 2022-2024.

With further regard to the institutional data, it is noted that the institutional data can, as just some examples, include one or more of: a) retention rate (e.g., NCES-definition retention rate); b) tuition amount; c) financial aid awarded; d) admission statistics (e.g., SAT/ACT or other college admission examination scores, and/or GPAs of accepted applicants); e) student body size; f) institution type (e.g., public, private, not-for-profit private, for-profit private, and/or not-for-profit religious); g) student/faculty ratio; h) teacher salary; i) educational offerings (e.g., degrees); j) extracurricular offerings (e.g., organizations, services, and/or athletic associations); k) full-time/part-time student ratio; and l) in/out-of-state student ratio. As noted, a single-vector sequence which is provided as input (during training or when requesting prediction) to the RNN can correspond to a given year (e.g., a current year). Where retention rate is included in such a sequence, the retention rate can, for instance, be the latest available retention rate. Alternately or additionally, such included retention rate can include historical retention rate data. Accordingly, such included retention rate can include (e.g., via a vector) retention rate data other than the latest available retention rate (e.g., data for one or more years prior to latest data can be included).

With further regard to the external data, it is noted that the external data can, as just some examples, include one or more of: a) unemployment rate; b) stock index change rate; c) birth rate; d) jobs added to economy; and e) student loan interest rate.

According to various embodiments, the training dataset for the RNN of the institutional retention forecasting tool can be compiled using various educational information datasets (e.g., the NCES IPEDS dataset). As just one illustration, akin to the training of the RNN of the admissions funnel forecasting tool, training of the RNN of the institutional retention forecasting tool can utilize data from 2,860 higher education institutions with an average of 11.62 years of data from each institution, yielding 33,231 total years of institutional data for training of the RNN. Also, according to various embodiments, a single RNN can be trained for use by multiple higher education institutions, while in other embodiments a separate RNN can be trained for each higher education institution. In these embodiments, the training dataset for the RNN can include data, of the sort discussed above, for that institution.

The institutional retention forecasting tool can use the trained RNN in a number of ways. For example, as discussed above, the tool can use the RNN to generate predicted institutional student retention values for r (e.g., r=3) time units (e.g., years) in the future. As another example, the tool can use the trained RNN in making specific recommendations to higher education institutions. As just one example, where an institution indicates a desire to increase institutional student retention rate, one or more machine learning approaches can be used by the tool to identify which of alterable institutional data factors appear to drive institutional student retention higher or lower. As an illustration, the tool, in this way, can determine that increasing teacher salary and lowering the in/out-of-state ratio would each likely lead to higher institutional student retention.

### Tools: Student Major Recommendation System Tool

According to various embodiments, a student major recommendation system tool can be provided. The student major recommendation system tool can provide suggestions of alternative majors for yet-to-graduate students who are considering switching majors. In some embodiments, the tool can also suggest that a student's current major be maintained. As such, the tool can aid a higher education institution in guiding students who are considering changing majors.

The student major recommendation system tool can utilize an MLM. According to various embodiments, the MLM utilized by the early warning student retention tool can be classifier. As one example, the classifier can be a Bayes classifier (e.g., a multinomial naive Bayes classifier or other Naive Bayes classifier). As another example, the classifier can be a neural network-based classifier (e.g., a multilayer perceptron (MLP)-based classifier).

In various embodiments, a training dataset for the MLM can be compiled using historical data (e.g., courses taken and grades earned) regarding various students. Further, the training dataset can include historical data regarding corresponding majors with which those students graduated.

In particular, a given training data input can correspond to a given student who has graduated with a given major. More specifically, the training data input can be made up of a vector which conveys the courses taken by the student and the grades achieved. A given training data output can be a vector which indicates the given major. In this way, the MLM can be trained to predict the majors of the graduated students whose data makes up the training dataset, using their courses and grades. In various embodiments, the noted data can be split into a training dataset and a testing dataset, thereby facilitating a determination of how well the trained MLM is able to predict student majors.

Moreover, in various embodiments, preparation of the training data can include masking out portions of student history. For example, within the training dataset data a selected quantity of final years of study can be masked out. In this way, the MLM can become more robust at generating change-of-major suggestions for students who are at varying points within their academic careers (e.g., freshman versus sophomore versus junior).

More specifically, assuming four-year courses of study, within the training dataset data a final years of study can be masked out, allowing the MLM to become more robust at generating suggestions for students who are within their (4-a)th year of study. As an illustration for a=1, masking out the final year of study can make the MLM more robust at generating change-of-major suggestions for students who are within their third year of study. As illustration for a=3, masking out the three final years of study can make the MLM more robust at generating change-of-major suggestions for students who are within their first year of study. In some embodiments, a single MLM can be trained (or a single MLM per institution), wherein various portions of the training data pool are chosen for application of various values of a for purposes of masking out (e.g., certain portions of the training data pool can be selected for masking out according to a=1, while other portions of the training data pool can be selected for masking out according to a=0). In other embodiments, a separate instance of the MLM (or a separate instance of the MLM per institution) can be trained for each value of a. As such, as one example, one MLM can be trained with all masking out according to a=3, with this MLM being employed for generating suggestions for freshman considering changing majors. Further according to the example, another MLM can be trained with all masking out according to a=2, with this MLM being employed for generating suggestions for sophomores considering changing majors.

Once trained, the MLM can take as input—with respect to a given student who is considering changing their major—a vector conveying the courses taken by the student and the grades achieved. Subsequently, the MLM can output a vector conveying a suggested major for the student. It is noted that the major suggested by the MLM for the student can be viewed as a major which has, as its corresponding coursework, classes similar to classes with which the student has been successful. Also, the major suggested by the MLM for the student can be viewed as a major similar to a major with which the student has been successful. Further, the major suggested by the MLM for the student can be viewed as a major with which the student is most closely associated, according to the dataset with which the MLM was trained (e.g., viewed as a major with which students having similar academic profiles, in terms of classes taken and grades earned, have found success).

According to various embodiments, the MLM can return more than one suggested major for a student. In particular, as referenced the MLM can be viewed as returning a major with which a given student is most closely associated. Moreover, according to various embodiments, the MLM employed can be an MLM—such as a multinomial naive Bayes model or multiclass neural network classifier—which returns multiple output labels, along with a probability of each label. As such, in these embodiments the MLM can return multiple majors as being ones with which the student is most closely associated, along with a probability value for each. The tool can use such probability values in providing multiple major suggestions for the student. For example, a threshold can be established, and those majors for which the MLM outputs a probability value exceeding the threshold can be provided as multiple suggested majors for the student. In some embodiments, multiple thresholds can be used. Moreover, in various embodiments the tool can further use such probability values in ranking suggested majors for the student (e.g., the majors which exceed the one or more thresholds can be ranked according to corresponding probability value, with higher probability values listed first).

As noted, in some embodiments, the tool can also suggest that a student's current major be maintained. As one example, such a circumstance can arise where the MLM outputs a single major for a student, and this single major is the major which the student is presently pursuing. As another example, such a circumstance can arise where the MLM outputs multiple majors with differing corresponding probabilities, but no major other than the current major of the student has a corresponding probability exceeding a given threshold.

As such, the student major recommendation system tool can assist higher education institution administration by yielding, for a yet-to-graduate student, one or more alternative majors with which the student is expected to enjoy success, or in the alternative offer the suggestion that a student continue with their current major.

### Infrastructure Software Modules: Overview

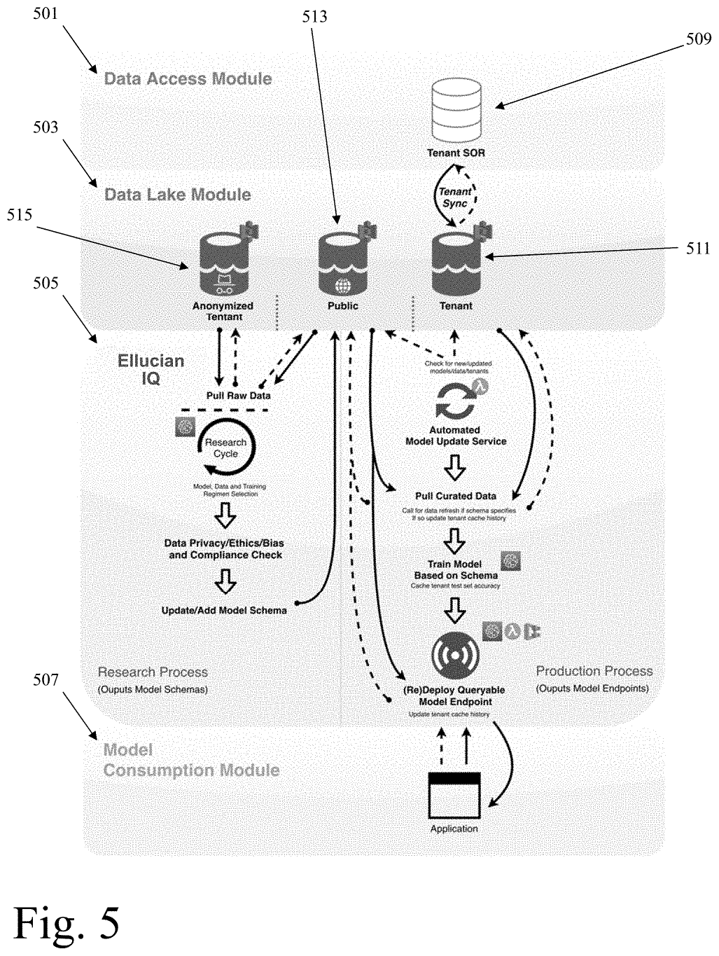

With reference to FIG. 5, the above-described tools can be supported by infrastructure software modules, including a data access/domain model module 501 (depicted as “Data Access Module”), a data lake module 503, a research/production module 505 (depicted as “Ellucian IQ”), and a model consumption module 507. The data access/domain model module 501 can provide functionality including hosting data of various higher education institutions. The data lake module 503 can provide functionality including storing native-format data pulled via the data access/domain model module 501, and from other sources. Then, the research/production module 505 can provide functionality including research-oriented operations such as testing MLMs for possible deployment and generating corresponding schemas. The research/production module 505 can also provide functionality including production-oriented operations such as training MLMs for deployment purposes, offering endpoints via which MLMs can be accessed, and providing for MLM updates. The model consumption module 507 can provide functionality including providing an Application Programming Interface (API) via which deployed MLMs can be accessed, such as by the noted tools. Various aspects of these infrastructure software modules will now be discussed in greater detail.

### Infrastructure Software Modules: Data Access/Domain Model Module

The data access module can host data which corresponds to various higher education institution tenants. As just one example, the module can utilize cloud infrastructure to host such higher education institution. In various embodiments, each higher education institution tenant can have a separate data access environment that can access only the data of that particular institution. In other embodiments, a given higher education institution can have access to some or all of the data of other higher education institutions, such as according to data-sharing agreement between the institutions. As an illustration, such a circumstance can arise where multiple institutions are part of a system, such as a state university system.

The data access module can, in various embodiments, store (509) the data of the various higher education institutions in a common format. Such storing of data in a common data format can provide benefits including supporting data integration among applications. Further, in various embodiments the module can store data in a format based upon a semantic domain network model for the domains of higher education and its administration. As an example, such a semantic domain model-based format can utilize the Ellucian Ethos Data Model (EEDM). EEDM provides a catalog of the things and concepts in the domain of higher education and its administration. Each thing and concept is treated as a separate entity in EEDM. Further in EEDM, such an entity can be assigned a single name, which can be utilized by both business and technical audiences. As such, benefits including improved interface between these two audiences can accrue.

Further, in various embodiments the data access module can generate reports regarding the data of higher education institution tenants. As an example, the module can utilize a Database Management System (DBMS)-based approach in generating these reports. As an example, module can utilize Hyperion Structured Query Reporter (SQR), or another reporting language, in performing the report generation.

### Infrastructure Software Modules: Data Lake Module

As noted, the data lake module 503 can store native-format data pulled via the data access/domain model module 501, and from other sources. In this way, the data lake module 503 can—as opposed to acting as a real-time system of record (e.g., a store to which generated data is directly and/or primarily written)—act as a general repository of native format information. The data lake module 503 can, for instance, utilize cloud storage offered by a cloud computing and/or cloud storage container provider (e.g., Amazon S3, DynamoDB, or Microsoft Azure Storage can be used).

The data lake module 503 can, for instance, utilize three types of data lakes: a higher education institution tenant lake, a public lake, and a de-identified/anonymized higher education institution tenant lake. A data lake of the tenant lake type (e.g., lake 511) can hold higher education institution tenant data obtained from the data access module. Then, a data lake of the public lake type (e.g., lake 513) can hold external data obtained from public data sources. Further, a data lake of the de-identified/anonymized tenant lake type (e.g., lake 515) can hold higher education institution tenant data which has been obtained from the data access module, and subsequently masked, anonymized, and/or pseudoanonymized. There can be multiple data lakes of a given type. For instance, there can be a data lake of the tenant lake type for each higher education institution tenant.

With further regard to the tenant lake type, as noted there can be a data lake of this type for each higher education institution tenant. The data lake module 503 can periodically use the data access module to pull data for a given tenant. Subsequently, the data lake module 503 can store the pulled data in the particular tenant lake which corresponds to that tenant. Storage can be, for instance, in the EEDM format. The MLMs of the tools described herein do not typically require real-time access to higher education institution tenant data. As such, various resource-intensive operations (e.g., data curation and model training) can operate upon data held in a tenant data lake. As such, these operations need not access such data directly via the data access module. Such can yield benefits including improved use of resources.

With further regard to the public lake type, there can be, in various embodiments, a single data lake of the public lake type. This single public data lake can be accessible to, and on behalf of, all higher education institution tenants. As referenced, this lake can hold external data drawn from the public domain. Such public domain data can, as examples, include data from the NCES, the U.S. Bureau of Labor Statistics (USBLS), and the U.S. Centers for Disease Control and Prevention (CDC). As a particular example, the NCES data can include the IPEDS dataset, a dataset which contains information on most private and public universities in the U.S.

By providing a public lake for all tenants to access, the data lake module 503 can allow MLMs to be trained using data that is external to particular educational institutions. Such training of MLMs utilizing external data can be advantageous, as educational institutions are typically affected by more than just internal factors. For instance, as referenced above, the MLM for the institutional retention forecasting tool can utilize external data. As another advantage, the use of a single public data lake can prevent unnecessary duplication of public domain data.

With further regard to the de-identified/anonymized tenant data lake type, there can be, in various embodiments, one or more data lakes of the de-identified/anonymized tenant data lake type. As referenced, such one or more data lakes can hold masked, anonymized, and/or pseudonymized tenant data.

The masked, anonymized, and/or pseudonymized tenant data of the one or more de-identified/anonymized tenant lakes can be used in various research operations, such as those performed by the research/production module 505. Such research operations can include exploring, manipulating, testing, and selecting MLMs, and creating training regimens for MLMs. The research/production module 505 is discussed in greater detail below. In various embodiments, there can be partnering with various higher education institution tenants. This partnering can include working with the tenants to mask personally identifiable data (PID) from their data, anonymize their data, and/or pseudoanonymize their data. Subsequently, such masked, anonymized, and/or pseudoanonymized data can be received by the data lake module 503 from the higher education institution tenants, and stored in the de-identified/anonymized tenant lake(s) for research-only use (i.e., not for production). In some embodiments, the data can be received from the tenants at the data lake module 503 prior to masking, anonymizing, and/or pseudoanonymizing, and subsequently masked, anonymized, and/or pseudoanonymized by the data lake module 503. As such, by providing data that is representative of the problems being solved, the data of the one or more de-identified/anonymized tenant lakes can allow the research/production module 505 to accurately perform various operations.

In various embodiments, the data lake module 503 can perform operations including the automated creation of MLM training datasets and query datasets, and allowing for the generalization of calls for data. For example, as to the automated creation of training datasets, after the below-discussed research cycle of the research/production module 505 has completed as to the model creation process, scripts can be created—and used in conjunction with the data lake module 503—so as to enrich and/or curate training datasets. In particular, these scripts can be submitted to the data lake module 503 by the research/production module 505. Subsequently, the data lake module 503 can utilize the scripts to regenerate fresh training datasets when data within one or more of the data lakes has been updated. By performing automated dataset creation when data is updated, the data lake module 503 can offer benefits such as enabling the for operation at scale. As to allowing for the generalization of calls for data, the data lake module 503 can allow for calling of datasets (e.g., by the research/production module 505) using the name of a tenant, or using an identifier of a tenant rather than, for instance, using hardcoded values. Such can provide advantages including allowing for datasets to be called methodologically even though locations of higher education institution tenant data can vary from tenant to tenant.

### Infrastructure Software Modules: Research/Production Module—Overview

The research/production module 505 can perform both research process operations and production process operations. The research process operations can include utilizing the data lake module 503 to access data, using the accessed data in auditioning various MLMs for possible deployment, selecting various of those MLMs as ones to be deployed, and generating schemas for those MLMs which have been selected. Such a schema can specify information for a given MLM deployment, such as MLM to be utilized, data preparation/preprocessing script to be utilized, and training script to be utilized. The production process operations can include accessing the schemas generated via the research process operations, and using the generated schemas in MLM deployment. The research process operations and the production process operations will now be discussed in greater detail.

### Infrastructure Software Modules: Research/Production Module—Research Process Operations

The research process can begin with the research/production module 505 using the data lake module 503 to access raw data for use in a new or updated MLM which is being considered for possible deployment. In some embodiments, such data access can be performed in an automated fashion, while in other embodiments the data access can be performed manually.

In some embodiments the data obtained via the data lake module 503 can be brought into an interactive machine learning coding/visualization notebook environment, such as a Jupyter notebook environment (e.g., provided by a cloud-based machine learning platform such as Amazon SageMaker). Using the notebook environment, data scientists can explore the data, and select relevant input data and output data to use in conjunction with an under-consideration MLM. In other embodiments, the research/production module 505 can use one or more automated processes (e.g., automated feature-selection processes) to find such relevant input data and output data. The found/selected input data and output data can be used, for instance, by the research/production module 505 in generating a training set for an under-consideration MLM.

A research cycle can begin once one or more training datasets have been prepared, as discussed. MLMs can be quickly implemented, trained, and finetuned via this research cycle. After one or more MLMs have been tested for a given deployment (e.g., with their test set results and performance benchmarks being recorded), an initial MLM can be selected for further testing. If such testing yields results which do not meet required benchmarks for the given deployment, one or more further MLMs can be evaluated, and/or a new dataset can be prepared. The output of the research cycle for a given deployment can include a selected set of input data and output data, an MLM, and a training regimen (e.g., including training scripts). The research/production module 505 can use these data elements in generating a schema. More specifically, the schema which is generated by the research/production module 505 can contain various fields, including but not limited to: a) specification of the MLM to be employed (e.g., via MLM identifier, name, and/or version; b) specification of the corresponding tool or product; c) specification of the location and version of corresponding data preparation/preprocessing scripts; d) specification of the location and version of training scripts; e) specification of the data version (e.g., training data version); and/or f) specification of the update frequency/time.

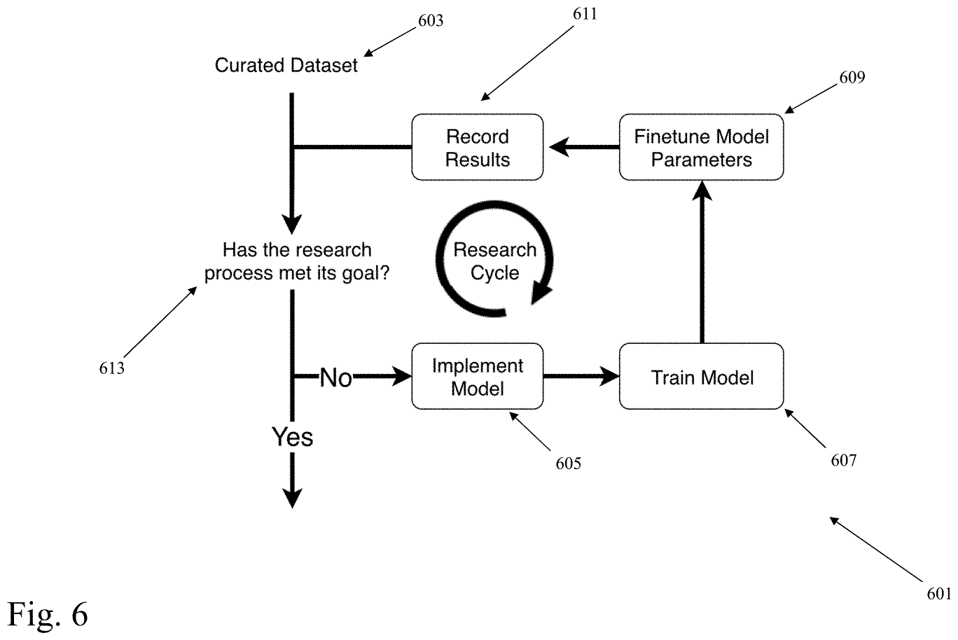

Turning to FIG. 6, shown is example research cycle 601. As reflected by the figure, the research cycle 601 can utilize a given dataset 603. Further, a given model can be implemented (605), trained (607), subjected to parameter finetuning (609), and subjected to testing/recording of testing results (611). Further, determination can be made by the research/production module 505 as to whether or not at-hand goals (e.g., regarding prediction accuracy) have been met (613).

The generated schema can, in various embodiments, be checked for compliance with data privacy rules, data ethics rules, and/or data/AWL bias rules. In some embodiments, this check can be performed by a data privacy and ethics review board. In other embodiments, the research/production module 505 performs this check in an automated fashion by, for instance, running a known and programmable list of biases (e.g., regarding race or gender) against the at-hand MLM and the dataset to identify whether those biases could be present in the schema. Subsequent to successful completion of the check, the generated schema can be deployed by the research/production module 505. In embodiments where there is not checking of the generated schema for compliance with data privacy rules, data ethics rules, and/or data/AI/bias rules, the schema can be directly deployed subsequent to its generation by the research/production module 505.

In some embodiments, such deployment can include addition of the schema to the public data lake. In these embodiments, when the below-discussed update service of the research/production module 505 is run, it can recognize that a new (or updated) schema has been available. Subsequently, the update service can begin rollout of the corresponding MLM.

### Infrastructure Software Modules: Research/Production Module—Production Process Operations

As referenced, the production process operations can include accessing schemas generated via the research process operations, and using the generated schemas in MLM deployment. In performing these operations, the research/production module 505 can utilize a model update service, a model training service, and an endpoint service.

For a given deployed MLM, the model update service can be aware of which version of the MLM is currently in use for the deployment. Further, in various embodiments, the model update service can be aware of which version of data (e.g., training data) currently corresponds to the deployment (e.g., which version of the training data was used in training the currently-in-use version of the MLM). The model update service can (e.g., periodically) determine whether or not a newer version of the given MLM exists. Likewise, in various embodiments, the model update service can determine whether or not a newer version of the data exists. In making these determinations, the model update service can, consult the schema which corresponds to the deployment. Accordingly, the model update service can, for instance, access the schema via the public data lake. Where the model update service determines that a newer version of the MLM and/or data exists, the model update service can call the model training service. In response, the model training service can perform MLM training in view of the new-version MLM or data. In calling the model training service, the model update service can pass various parameters. These parameters can include a specification of the consulted schema. These parameters can also include a specification of a higher education institution tenant (e.g., via indication of an identifier of the tenant) with respect to which the model training service is to operate. The model training service is discussed in further detail below.

As an illustration of the functionality of the model update service, suppose that higher education institution tenant A was running version 1 of MLM A. Suppose further that the model update service consulted, via the public data lake, the relevant schema, and determined that there was a new version—version 2—of MLM A. Under these circumstances, the model update service can call the model training service. In particular, by passing as a parameter in the call indication of the relevant schema which corresponds to model A version 2, the model update service can cause the model training service to utilize the schema for model A version 2. Further, the model update service can pass via the call the relevant tenant ID. In this way, the model training service can have access to the proper tenant data. The model update service can, in various embodiments, check for newly-available MLMs (e.g., MLMs for which no previous version existed), and/or for newly-joined tenants, or tenants with respect to which there have been updates.

In some embodiments, in the case of a public MLM (i.e., an MLM available to all higher education institution tenants), the research/production module 505 can train only a single instance of the MLM. In these embodiments, a provider/implementer of the infrastructure software modules can be considered to be the tenant for the MLM, and the MLM can be associated with a given tool or product. Further in these embodiments, various higher education institution tenants can subscribe to the MLM and/or tool. As such, in the case of a new version of the public MLM becoming available, the model update service can identify the tool or product in the relevant schema, and can call the model training service so as to start the model training service for all higher education institution tenants who have subscribed to the tool or product. In this way, the single instance of the MLM can be trained according to the data of the various tenants who have subscribed to the tool or product. In the case of a training dataset update, the model update service can cause the model training service to operate with respect to the updated training dataset via the above-discussed passage of parameters.

The model update service can, in various embodiments, utilize tenant cache histories in its operations. Such a tenant cache history can include, for example MLM name and/or identifier, MLM version, data version (e.g., training dataset version), and creation date/time. In utilizing tenant cache histories, the model update service can check the tenant cache histories against the current state (e.g., as specified by a relevant schema stored in the public data lake), and can call the model training service so as to keep higher education institution tenants up-to-date. The model training service can, in various embodiments, be hosted on a cloud-based machine learning platform (e.g., Amazon SageMaker). Moreover, in various embodiments the model update service can run via a cloud-based code execution platform (e.g., AWS Lambda).

As referenced, the model training service can train machine learning models. For instance, the model training service operates in this way when called by the model update service in response to the model update service determining that a given MLM has been updated to a new version. The model training service can, in various embodiments, be managed by a cloud-based machine learning platform. Further, in various embodiments the model training service can use virtual server instances (e.g., Amazon EC2 instances or Microsoft Azure instances) when performing model training.

The model training service can, in various embodiments, be supplied with training scripts. For example, as noted, in calling the model training service, the model update service can pass as a parameter reference to a schema, where the schema can specify such a training script. Utilizing such a training script, the model training service can perform operations including automatically provisioning instances, training machine learning models, and shutting down such instances once training is complete. In some embodiments, a monitoring service (e.g., a cloud-based monitoring service such as Amazon CloudWatch) can be used to log various metrics regarding MLM training and/or testing. Among these metrics can be the accuracy of a given MLM when generating predictions from a given test dataset. Such a determined accuracy can, in some embodiments, be cached by the model update service. In various embodiments, thresholds which consider these logged accuracies can be implemented. In particular, the research/production module 505 can, in these embodiments, opt to not deploy an MLM which exhibits poor accuracy according to these thresholds.

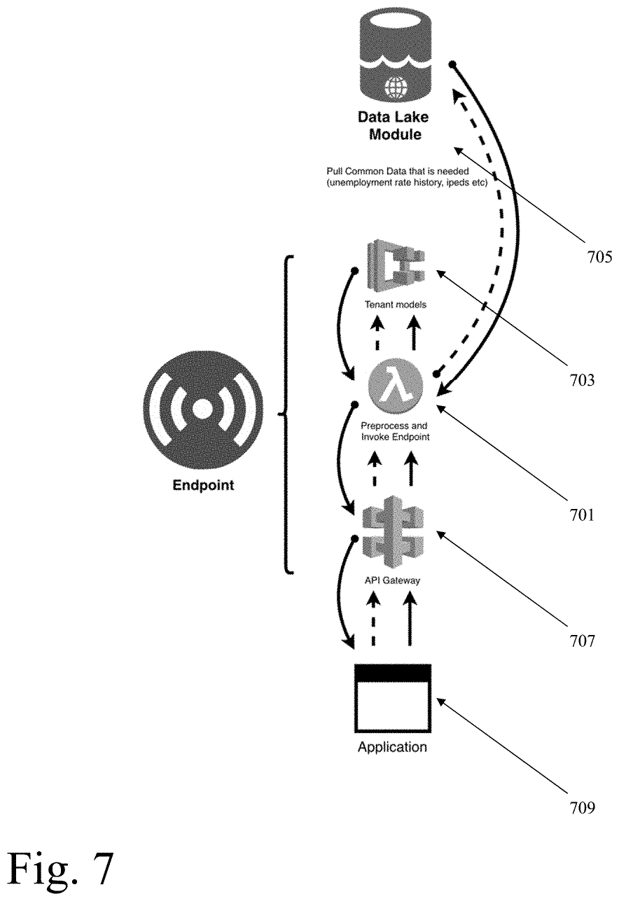

As noted, the research/production module 505 can offer endpoints via which MLMs can be accessed. These endpoints can be implemented via the endpoint service. For instance, the model update service or model training service can call the endpoint service in order to deploy or redeploy an endpoint for a given MLM (e.g., the model training service can call the endpoint service in this way subsequent to training a given MLM). According to various embodiments, in offering an endpoint via which a given MLM can be accessed, the endpoint service can establish a corresponding API gateway. Turning to FIG. 7, depicted is example functionality regarding the research/production module 505 and the endpoint service. In an aspect, depicted in FIG. 7 is the endpoint service deploying/evoking (701) a given endpoint for at least one tenant MLM (703), including performing corresponding preprocessing operations such as accessing called for data (705). Also shown in FIG. 7 is the endpoint service establishing a corresponding API gateway (707). Using the API gateway, an application/tool can access (709) at least one MLM.

Moreover, according to various embodiments, a trained MLM can be containerized in a standalone environment with all its dependencies. This containerization can be performed by the endpoint service. A given model can, for example, be hosted on a virtual server instance (e.g., an Amazon EC2 instance) and be callable via API gateway. Additionally, multiple containerized models can be hosted on each virtual server instance

### Infrastructure Software Modules: Model Consumption Module

A given machine learning model provided by the infrastructure software modules can be called via an API gateway established by the endpoint service. The model consumption module 507 can provide capabilities which aid in such calling of the gateway. For instance, a function (e.g., a lambda function) can be provided by the model consumption module 507. This function can access, via the data lake module 503, data (e.g., public data) called for by a given MLM in order to make a requested inference/prediction. The function can concatenate such data (e.g., public data) with any data passed in by a calling tool or application. Subsequently, the function perform any called for preprocessing of the concatenated data. Further, the function can make a call to the endpoint of the given MLM.

Then, the endpoint can pass to the MLM the information (e.g., the preprocessed, concatenated data) received via the call. The endpoint can then retrieve the inference/prediction which is outputted by the MLM. Next, the endpoint can pass the inference/prediction back to the function. Subsequently, the inference/prediction can be passed to the API gateway, and then to the tool or application.

It is noted that, in various embodiments, authorization tokens can be used. In these embodiments, a tool or application can access the API gateway. Subsequently, the API gateway can forward to the function an authorization token which corresponds to the tool or application. In these embodiments, the function can then utilize the token to authenticate the tool or application before proceeding further.

Moreover, in various embodiments, a module consumption module is not provided. In these embodiments, tools and/or products can directly access a given API gateway, without the assistance of the noted function (e.g., without the assistance of the noted lambda function).

As such, the endpoint and model consumption module 507 can enable machine learning functionality to be embedded into various software applications (e.g., embedded into Ellucian applications, and/or into any other applications regarding higher education support and administration).

### Hardware and Software

According to various embodiments, various functionality discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system.

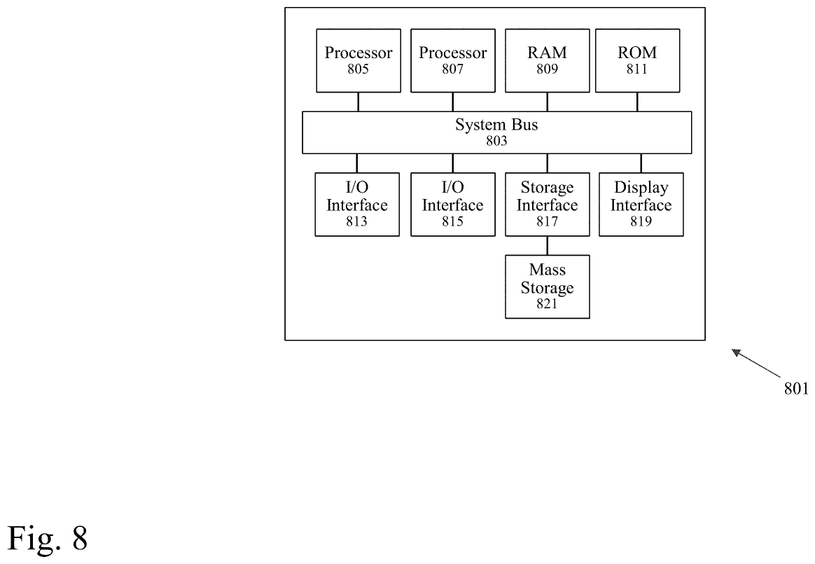

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 8 is an example computer employable in various embodiments of the present invention. Exemplary computer 801 includes system bus 803 which operatively connects two processors 805 and 807, random access memory (RAM) 809, read-only memory (ROM) 811, input output (I/O) interfaces 813 and 815, storage interface 817, and display interface 819. Storage interface 817 in turn connects to mass storage 821. Each of I/O interfaces 813 and 815 can, as just some examples, be a Universal Serial Bus (USB), a Thunderbolt, an Ethernet, a Bluetooth, a Long Term Evolution (LTE), an IEEE 488 and/or other interface. Mass storage 821 can be a flash drive, a hard drive, an optical drive, or a memory chip, as just some possibilities. Processors 805 and 807 can each be, as just some examples, a commonly known processor such as an ARM-based or x86-based processor. Computer 801 can, in various embodiments, include or be connected to a touch screen, a mouse, and/or a keyboard. Computer 801 can additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using Python, Java, Swift, C, C++, C #, and/or another language. Corresponding program code might be placed on media such as, for example, DVD, CD-ROM, memory card, and/or floppy disk. It is noted that any indicated division of operations among particular software modules is for purposes of illustration, and that alternate divisions of operation may be employed. Accordingly, any operations indicated as being performed by one software module might instead be performed by a plurality of software modules. Similarly, any operations indicated as being performed by a plurality of modules might instead be performed by a single module. It is noted that operations indicated as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

### RAMIFICATIONS AND SCOPE

Although the description above contains many specifics, these are merely provided to illustrate the invention and should not be construed as limitations of the invention's scope. Thus, it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

1. A computer-implemented method, comprising:
providing, by a computing system, to a machine learning model, input data for a student, wherein the input data comprises course data;
receiving, by the computing system, from the machine learning model a prediction output, wherein the prediction output regards courses not taken by the student; and
generating, by the computing system, using the prediction output, one or more possible class schedules for the student.

2. The computer-implemented method of claim 1, wherein the input data comprises one or more of data regarding courses taken by the student, or data regarding grades achieved by the student.

3. The computer-implemented method of claim 1, wherein the prediction output comprises grade predictions for the courses not taken by the student.

4. The computer-implemented method of claim 1, further comprising:
determining, by the computing system, course requirements for the student; and
selecting, by the computing system, using the prediction output, for each of one or more courses specified by the course requirements, at least one course at which the student is likely to succeed.

5. The computer-implemented method of claim 1, wherein said generating the possible class schedules for the student comprises utilizing, by the computing system, one or more of epsilon support vector regression or a regression tree.

6. The computer-implemented method of claim 1, wherein the machine learning model is an autoencoder.

7. A system comprising:
at least one processor; and
a memory storing instructions that, when executed by the at least one processor, cause the system to perform the computer-implemented method of claim 1.

8. A non-transitory computer-readable storage medium including instructions that, when executed by at least one processor of a computing system, cause the computing system to perform the computer-implemented method of claim 1.

9. A computer-implemented method, comprising:
providing, by a computing system, to a machine learning model, input data for a student, wherein the input data comprises one or more of institutional data regarding the student or data regarding external factors;
receiving, by the computing system, from the machine learning model, a prediction output, wherein the prediction output indicates a prediction as to whether or not the student is at academic risk; and
compiling, by the computing system, using the prediction output, a list of at-risk students.

10. The computer-implemented method of claim 1, wherein the machine learning model is a decision tree classifier.

11. The computer-implemented method of claim 9, wherein the institutional data regarding the student comprises one or more of tuition amount paid, per-semester tuition amount, student admission statistics, major, number of semesters attended, number of courses failed, average course grade, average number of courses taken per semester, or average number of students enrolled in courses taken.

12. The computer-implemented method of claim 9, wherein the data regarding external factors comprises one or more of resident status, country unemployment rate, local unemployment rate, or stock index change rate.

13. The computer-implemented method of claim 9, further comprising:
receiving, by the computing system, from the machine learning model, confidence information regarding the prediction output; and
using, by the computing system, the confidence information to rank the list of at-risk students.

14. The computer-implemented method of claim 9, further comprising:
determining, by the computing system, one or more weights employed by the machine learning model; and
determining, by the computing system, utilizing the determined weights, one or more factors of one or more of student success or student failure.

15. The computer-implemented method of claim 14, further comprising:
analyzing, by the computing system, one or more tree paths of the machine learning model; and
generating, by the computing system, utilizing results of the tree path analysis, one or more of a particular set of factors and corresponding values which led to a given prediction output from the machine learning model, or overall guidance regarding correlations between factors and corresponding values, and prediction output generation by the machine learning model.

16. A system comprising:
at least one processor; and
a memory storing instructions that, when executed by the at least one processor, cause the system to perform the computer-implemented method of claim 9.

17. A non-transitory computer-readable storage medium including instructions that, when executed by at least one processor of a computing system, cause the computing system to perform the computer-implemented method of claim 9.

18. A computer-implemented method, comprising:
providing, by a computing system, to a machine learning model, admissions funnel input data, wherein the admissions funnel input data comprises an input sequence of j vectors, and wherein each vector of the input sequence corresponds to a point of time within a range t₁ . . . tⱼ;
receiving, by the computing system, from the machine learning model, a prediction output, wherein the prediction output comprises an output sequence of j admissions funnel vectors, and wherein each vector of the output sequence corresponds to a point of time within a range t₂ . . . tⱼ₊₁; and
utilizing, by the computing system, as an admission funnel prediction for a yet-to-occur point in time, an admissions funnel vector, of the output sequence, corresponding to a point in time j+1.

19. The computer-implemented method of claim 18, wherein each vector of the input sequence is an admissions funnel vector comprising one or more of a quantity of students that apply, a quantity of students that are admitted, or a quantity of students that attend.

20. The computer-implemented method of claim 18, wherein each vector of the input sequence is an expanded vector comprising external factors, and one or more of a quantity of students that apply, a quantity of students that are admitted, or a quantity of students that attend.

21. The computer-implemented method of claim 20, wherein the external factors comprise one or more of country unemployment rate, local unemployment rate, stock index change rate, or birth numbers.

22. The computer-implemented method of claim 18, wherein each vector of the output sequence comprises one or more of a quantity of students that apply, a quantity of students that are admitted, or a quantity of students that attend.

23. The computer-implemented method of claim 18, wherein the machine learning model is a recurrent neural network.

24. The computer-implemented method of claim 18, further comprising:
utilizing, by the computing system, the prediction output in generating a higher education institution administrative recommendation.

25. A system comprising:
at least one processor; and
a memory storing instructions that, when executed by the at least one processor, cause the system to perform the computer-implemented method of claim 18.

26. A non-transitory computer-readable storage medium including instructions that, when executed by at least one processor of a computing system, cause the computing system to perform the computer-implemented method of claim 18.

27. A computer-implemented method, comprising:
providing, by a computing system, to a machine learning model, input data, wherein the input data comprises a single-vector input sequence, wherein the single-vector input sequence comprises a vector comprising one or more of institutional data or data regarding external factors, and wherein said vector of the single-vector input sequence corresponds to a point of time t;
receiving, by the computing system, from the machine learning model, a prediction output, wherein the prediction output comprises an output sequence of r student retention values, and wherein each value of the output sequence corresponds to a point of time within a range t+1 . . . t+r; and
utilizing, by the computing system, the output sequence in providing one or more student retention predictions.

28. The computer-implemented method of claim 27, wherein the institutional data comprises one or more of retention rate, tuition amount, financial aid awarded, admissions statistics, student body size, institution type, student/faculty ratio, teacher salary, educational offerings, extracurricular offerings, full-time/part-time student ratio, or in/out-of-state student ratio.

29. The computer-implemented method of claim 27, wherein the data regarding external factors comprises one or more of unemployment rate, stock index change rate, birth rate, jobs added to economy, or student loan interest rate.

30. The computer-implemented method of claim 27, wherein the machine learning model is a recurrent neural network.

31. The computer-implemented method of claim 27, further comprising:
utilizing, by the computing system, the prediction output in identifying alterable institutional factors which appear to drive institutional retention higher or lower.

32. A system comprising:
at least one processor; and
a memory storing instructions that, when executed by the at least one processor, cause the system to perform the computer-implemented method of claim 27.

33. A non-transitory computer-readable storage medium including instructions that, when executed by at least one processor of a computing system, cause the computing system to perform the computer-implemented method of claim 27.

34. A computer-implemented method, comprising:
providing, by a computing system, to a machine learning model, input data for a student, wherein the input data comprises course data;
receiving, by the computing system, from the machine learning model, a prediction output, wherein the prediction output indicates one or more academic majors; and
generating, by the computing system, using the prediction output, one or more suggested majors for the student.

35. The computer-implemented method of claim 34, wherein the input data comprises one or more of data regarding courses taken by the student, or data regarding grades achieved by the student.

36. The computer-implemented method of claim 34, wherein the machine learning model is one of a Bayes classifier or a multilayer perceptron-based classifier.

37. The computer-implemented method of claim 34, further comprising:
receiving, by the computing system, from the machine learning model, confidence information regarding the prediction output; and
using, by the computing system, the confidence information in ranking the suggested majors.

38. A system comprising:
at least one processor; and
a memory storing instructions that, when executed by the at least one processor, cause the system to perform the computer-implemented method of claim 34.

39. A non-transitory computer-readable storage medium including instructions that, when executed by at least one processor of a computing system, cause the computing system to perform the computer-implemented method of claim 34.

40. A computer-implemented method, comprising:
operating, by a computing system, a data access/domain model module, wherein the data access/domain model implements functionality comprising hosting higher education institution data;
operating, by the computing system, a data lake module, wherein the data lake module implements functionality comprising storing native-format data;
operating, by the computing system, a research/production module, wherein the research/production module implements functionality comprising one or more of testing machine learning models for possible deployment, generating schemas, training machine learning models for deployment, implementing machine learning model-access endpoints, or updating machine learning models; and
operating, by the computing system, a model consumption module, wherein the model consumption module implements functionality comprising providing a function usable in accessing deployed machine learning models.

41. The computer-implemented method of claim 40, wherein said generating schemas comprises generating schemas comprising one or more of a field specifying a machine learning model to be employed, a field specifying a tool or product, a field providing data preparation script information, a field providing training script information, a field specifying data version, or a field specifying update frequency/time.

42. A system comprising:
at least one processor; and
a memory storing instructions that, when executed by the at least one processor, cause the system to perform the computer-implemented method of claim 40.

43. A non-transitory computer-readable storage medium including instructions that, when executed by at least one processor of a computing system, cause the computing system to perform the computer-implemented method of claim 40.
